(19) United States
(12) Patent Application Publication
(10) Pub. No.: US 2025/0307852 A1
(43) Pub. Date: Oct. 2, 2025

(54) SYSTEMS AND METHODS OF CONTROLLING RETAIL PRODUCT ALLOCATION AND RETAIL MARKET VARIATIONS BASED ON CUSTOMIZED INSIGHT

(71) Applicant: Walmart Apollo, LLC, Bentonville, AR (US)

(72) Inventors: Ravishankar Balasubramanian, Bengaluru (IN); Ashwini Chandrashekharaiah, Bangalore (IN); Mohit Vijay, Branchburg, NJ (US); Suprit Saha, Kolkata (IN); Samhati Ghosh, Bangalore (IN); Pinaki Ranjan Brahma, Bangalore (IN); Peeyush Pashine, Durg (IN)

(21) Appl. No.: 18/864,486

(22) PCT Filed: May 8, 2023
(86) PCT No.: PCT/US2023/021355

§ 371 Date: Nov. 8, 2024

Related U.S. Application Data
(60) Provisional application No. 63/389,251, filed on Jul. 14, 2022.

(30) Foreign Application Priority Data
May 11, 2022 (IN) 202241027120

(51) Int. Cl. G06Q 30/0202; G06Q 10/087

(52) U.S. Cl. CPC G06Q 30/0202; G06Q 10/087

(57) ABSTRACT

Some embodiments provide a system to control retail product allocation, comprising: an anomaly detection system applying a series of anomaly detection models to business metric data to identify an anomaly of a category of products; a contextualization detection system applying contextual models to data relative to the anomaly and identifying contextual factors; a causal detection system applying causal inference and determination models to sets of relevance data as a function of the contextual factors to determine influence attribution factors that are predicted to have been factors in causing the threshold variation, and apply attribution prioritization models to define relevancy scores to the influence attribution factors and prioritize the influence attribution factors; a personalization recommendation system applying personalization models to the prioritized influence attribution factors and the contextual factors as a

### CROSS-REFERENCE TO RELATED APPLICATIONS

This application claims the benefit of U.S. Provisional Application No. 63/389,251 filed Jul. 14, 2022, and claims priority to India application Ser. No. 20/224,1027120, filed May 11, 2022, all of which are incorporated herein by reference in their entirety.

### TECHNICAL FIELD

This invention relates generally to controlling product distribution.

### BACKGROUND

Retail sales of products typically vary dramatically over time. It is common to evaluate sales over time in attempts to identify how a product is performing. However, it would be beneficial to further improve the management of retail products.

### BRIEF DESCRIPTION OF THE DRAWINGS

Disclosed herein are embodiments of systems, apparatuses and methods pertaining to controlling product distribution in part through the identification of anomalies. This description includes drawings, wherein:

FIG. 1 illustrates a simplified block diagram of a retail product allocation control system, in accordance with some embodiments.

FIG. 2 illustrates a representation of a process implemented by the product allocation control system in identifying and providing the customized anomaly notification information relative to one or more detected anomalies corresponding to retail products and/or retail life cycle of product, in accordance with some embodiments.

FIG. 3 is a pictorial representation of exemplary relationships of cause-effect influence attributions, in accordance with some embodiments.

FIG. 4 illustrates a simplified representation of an example of customized anomaly notification information displayed through a graphical user interface of one or more recipient computing devices, in accordance with some embodiments.

FIG. 5 illustrates simplified representation of an exemplary textual summary of a customized anomaly notification information, in accordance with some embodiments.

FIG. 6 illustrates a simplified flow diagram of an exemplary process of controlling retail product allocation and providing customized anomaly notification information, in accordance with some embodiments.

FIG. 7 illustrates a simplified functional block diagram illustrating functions of anomaly detection in accordance with some embodiments.

FIG. 8 illustrates a simplified flow diagram of an exemplary process of anomaly detection, in accordance with some embodiments.

FIG. 9 shows an exemplary data ingestion and feature store creation, in accordance with some embodiments.

FIG. 10 shows an exemplary second stage of anomaly detection and attribution mapping, in accordance with some embodiments.

FIG. 11 illustrates an exemplary anomaly notification generation, with textual aspects of the alerts from the anomaly database to be surfaced on the graphical user interface insights dashboard, in accordance with some embodiments.

FIG. 12 illustrates an exemplary system for use in implementing methods, techniques, devices, apparatuses, systems, servers, sources and providing anomaly detection and customized anomaly notification information, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

The present embodiments provide machine learning based systems and methods that improve control over product management through the simplified and enhanced processing of a variety of different information from a multitude of sources. Further, the systems and methods utilize machine learning models to enhance the control over information provided to intended recipients in order to provide personalized information that is more relevant to the intended recipient, and/or more relevant to the responsibilities of the intended recipient (e.g., supervision that the intended recipient performs in controlling management of product distribution, product placement, product pricing, product marketing, manufacturing, equipment and/or other such aspects of product management over retail products). Still further, the application of the sets of machine learning models greatly reduced computational processing in improving the access to relevant information, while further significantly reducing computation overhead and memory storage needed.

Some embodiments provide systems to control retail product allocation includes an anomaly detection system that applies a series of machine learning anomaly detection models to one or more business metrics data (e.g., sales data, inventory data, on-time-in-full data, sales gross merchandising value (GMV), fill rates data, demand data, shipping data, etc.) relative to products being sold through a retailer to identify at least one anomaly relative to a threshold variation of the business metric over time of a category of products and/or one or more particular products. A contextualization detection system is included in some embodiments that applies a set of machine learning contextual models to the one or more business metrics data (e.g., non-sales data and the sales data) relative to the identified anomaly to identify contextual factors associated with the identified anomaly relative to different sales channels and geographic hierarchy of sales relative to the category of products. In some embodiments, a causal detection system is included that applies a set of machine learning causal inference and/or determination models to sets of relevance data having potential effects on the category of products as a function of the contextual factors associated with the first anomaly. The causal detection system determines influence attribution factors that are predicted to have been factors in causing the threshold variation in the business metric of products of the category of products, and applies a set of machine learning attribution prioritization models to define relevancy scores to the influence attribution factors and prioritize the influence attribution factors. Embodiments typically further include a personalization recommendation system that applies a set of machine learning personalization models to the prioritized influence attribution factors and the contextual factors or aspects of the identified anomaly as a function of a particular intended recipient type, of multiple different recipient types, intended to receive personalized anomaly notification information and controlling a display system to control a graphical user interface presenting customized anomaly notification information specific to the intended recipient type.

Some embodiments provide methods of controlling retail product allocation, comprising: identifying, based on applying a series of machine learning anomaly detection models to business metric data relative to products being sold through a retailer, an anomaly relative to a threshold variation in of a business metric over time of a category of products. Contextual factors are identified based on applying a set of machine learning contextual models to the business metric data (e.g., non-sales data and the sales data) relative to the first anomaly. The contextual factors are associated with the identified anomaly relative to different sales channels and geographic hierarchy of sales. Some embodiments determine, based on applying a set of machine learning causal inference and/or determination models to sets of relevance data having potential effects on the category of products as a function of the contextual factors associated with the identified anomaly, influence attribution factors that are predicted to have been factors in causing the threshold variation in the business metric of products of the first category of product. Further, some embodiments define, based on applying a set of machine learning attribution prioritization models, relevancy scores to the influence attribution factors and prioritizing the influence attribution factors. A set of machine learning personalization models are applied to the prioritized influence attribution factors and the contextual factors of the identified anomaly as a function of a particular intended recipient type, of multiple different recipient types, intended to receive personalized anomaly notification information, and a display system is controlled to control a rendering of a graphical user interface presenting customized anomaly notification information specific to the intended recipient type.

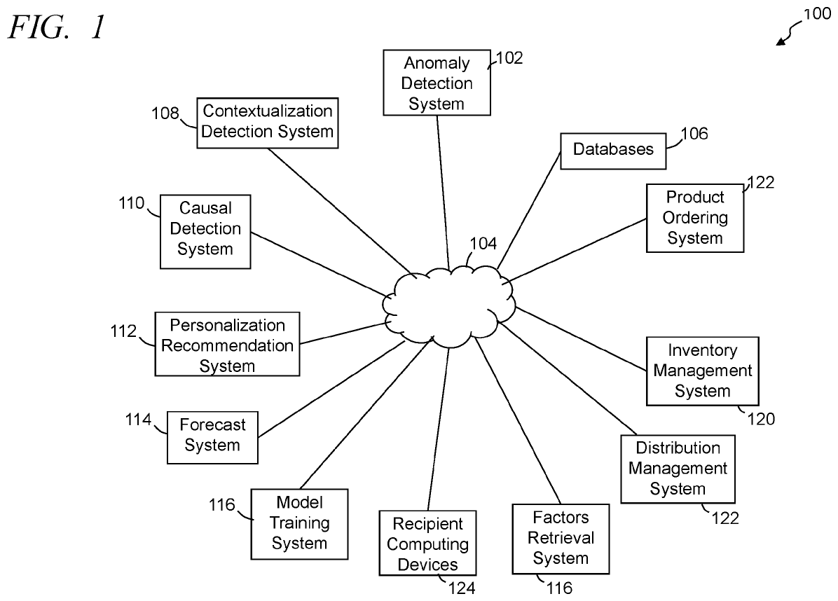

FIG. 1 illustrates a simplified block diagram of a retail product allocation control system 100, in accordance with some embodiments. The product allocation control system 100 includes an anomaly detection system 102 that is communicatively coupled over one or more distributed computer and/or communication networks 104 with one or more databases 106 and/or other relevant computer memory systems. The communication networks can be substantially any relevant communication network, such as but not limited to cellular communication network(s), the Internet, local area network(s) (LAN), wide area network(s) (WAN), Wi-Fi network(s), Bluetooth network, other such wired and/or wireless networks, or a combination of two or more of such networks. The product allocation control system 100 further typically includes a contextualization detection system 108, a causal detection system 110, and a personalization recommendation system 112.

Additionally, the product allocation control system 100 includes one or more machine learning model training systems 116 that is communicatively coupled with at least a model database and one or more training data databases. In some embodiments, the product allocation control system 100 further includes a forecast system 114. The contextualization detection system 108, the causal detection system 110, the personalization recommendation system 112, and the forecast system 114 are further communicatively coupled with one or more of the communication networks 104 enabling access to one or more databases 106 and/or communication with one or more other systems of the product allocation control system 100. Some embodiments further include and/or is typically in communication with one or more inventory management systems 120 that track retail product inventory associated with one or more retailers, one or more retail facilities, one or more retail sales channels and/or other such inventory information, and/or manages the communication of product allocation instructions in directing the transfer of products. Some embodiments include and/or are in communication with one or more product distribution management systems 122 that manage the distribution of products to and from retail facilities (e.g., warehouses, fulfillment centers, retail stores, etc.), along sales channels and/or to customers. The product allocation control system 100 is further in communication with and/or includes numerous different recipient computing devices 124. Typically, each of the recipient computing devices 124 is associated with a respective one of a product supplier, a retailer, a shipping service, or other such entity that is expected to request access to information to improve control of product allocation and/or distribution. The recipient computing devices 124 can include fixed computing devices (e.g., computers, servers, etc.) and/or mobile computing devices (e.g., laptops, tablets, smartphones, other such computing devices, or a combination of two or more of such devices).

Retail, consumer packaged goods (CPG) and other related companies have many product and business functions that affect and/or are responsible for driving business targets and goals to drive sales, revenues and/or profits. Typically, these business and product functions are represented by different groups or user personas (e.g., merchants, sales managers, account managers, product category advisers, replenishment managers, supply chain planners, market researchers, and other such types of personas each with defined functional responsibilities). The key performance indicators (KPI) and/or metrics that these user personas consider and/or consume are as varied as business metrics (e.g., sales and volume, supply chain metrics such as inventory-at-hand, lead times, fill-rates, market metrics such as customer trends and regional/local preferences, market share metrics, and other such metrics).

Further, these users often deal with high velocity and high volume omni-channel performance data and often, struggle to make informed business decisions in time. More often, the user personas deal with multitude of inter-dependent KPIs across these product functions, but previous systems are generally designed from a single user persona or business function and address only one or a very narrower sets corresponding KPIs or metrics. Alternatively, the present embodiments provide enhanced information that is customized for the particular intended recipient type of user enabling the users to make more informed decisions in real time to limit and often prevent adverse conditions and/or results. As such, the use of the customized anomaly notification often enables recipients to make decisions using relevant and current information that in part is focused on actionable insights. Such relevant information can be used at least in part in making more relevant decisions, such as to help limit or prevent loss of market share by enabling decisions to provide product distribution to achieve an effective assortment of products, limits loss of sales and/or revenues because product distribution can be more effectively controlled to meet demand (e.g., fill-rates, OTIF). Further, providing different customized anomaly notification information to different personas supports sustain growth across channels and geographies. Still further, the application of the machine learning models enables the correct identification of one or more root causes of anomalies, which allows accurate decisions to be made to limit deviations from goal targets. Additionally, the use of the customized anomaly information enables effectively channel investment and planning decisions.

For example, because of supply chain challenges, inventory for a specific category of products (e.g., cold beverages from a particular supplier) is low. This problem has different considerations for different personas. A supply chain planner (user persona) is likely primarily concerned with solving for supply versus demand. A category adviser (user persona) may be interpreting that this category of products are selling less, and accordingly may be planning to discontinue one or more products or plan promotions, even though the low sales is caused by the inventory issues and not lack of demand. A market researcher (user persona) may be wondering why sales of products of this category are lagging when customers are not purchasing the products (e.g., as a result of there being a lead time to restock, the customer may have moved to a different brand). Accordingly, different types or personas of recipients of information associated with evaluating product performance have different considerations, different factors to consider, different reaction times, and/or other such differences. The present embodiments, however, enhance the control of product distribution in part through the identification of relevant information. Some embodiments identify and/or control the presentation of customized retail product performance information as a function of the user persona with which each intended recipient is associated.

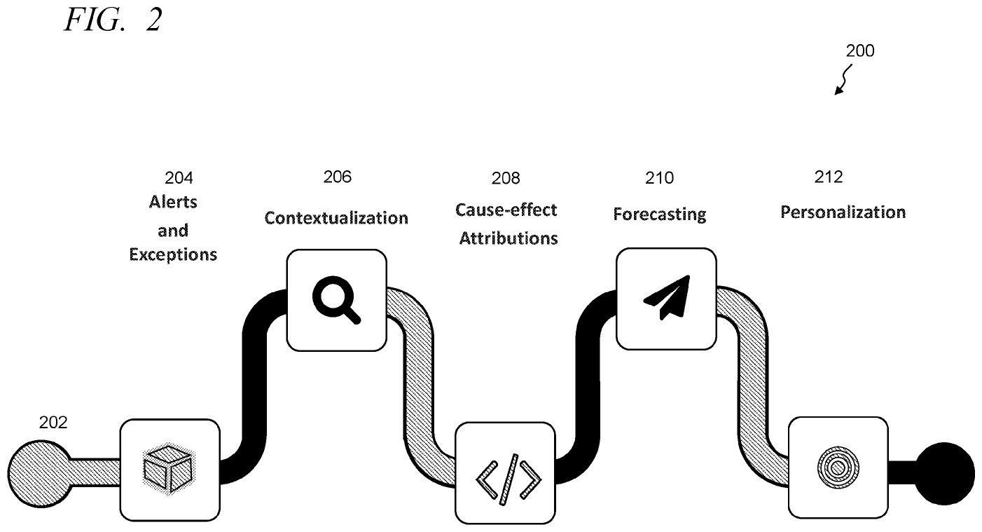

FIG. 2 illustrates a representation of a process 200 implemented by the product allocation control system 100 in identifying and providing the customized anomaly notification information relative to one or more detected anomalies corresponding to retail products and/or retail life cycle of product, in accordance with some embodiments. The product allocation control system 100 evaluates 202 extensive amounts of internal and external information that has effects on retail environments and/or sales. Anomalies or exceptions 204 are identified, and in some implementations clustering and anomaly patterns are identified. Some embodiments further identify contextualization information 206 that in part provides insight into the relevance of the anomaly. Based on the anomaly detection and/or contextualization, the product allocation control system 100 identifies the anomaly where within the retail environment respective anomalies are occurring. Causation attributions 208 corresponding to a cause of a respective anomaly are identified enable the product allocation control system 100 to not only provide information about the identification of the anomaly and where in the retail environment the anomaly is occurring, but further provide information about why an anomaly is predicted to be occurring. The causes may further be evaluated relative to a type of intended recipient expected to receive relevant anomaly information and the responsibilities and information more relevant to that intended type of intended recipients and/or specific intended recipient. Some embodiments apply forecasting 210 relative to expectations, goals and/or other relevant benchmarks or thresholds relative to the intended recipient, which enables the product allocation control system 100 to further provide information about what is predicted to happen in the future should those factors causing the anomaly continue and actions not be taken to address the anomaly. Based on the obtained identification of what the anomaly is and where within the retail environment the anomaly is occurring, in addition to the contextual information and prediction of why the anomaly is occurring, and what is forecasted to occur next, the product allocation control system 100 is configured to generate and present 212 anomaly notification information that customized for the type of intended recipient consuming the anomaly notification information.

Referring to FIGS. 1-2, the product allocation control system 100 applies a series of different extensively trained, machine learning models to a multitude of different information in identifying anomalies associated with products offered for sale through one or more suppliers, CPGs, and the like, and processing relevant information to identify select information that is most relevant to an intended type of recipient and/or a particular intended recipient. The application of these series of models further enables the control of a graphical user interface of a respective recipient computing device 124 to render customized anomaly notification information specific to an intended recipient and/or a recipient type with which the intended recipient is associated. Different potential recipients (sometimes may be referred to as users and/or information consumers) have different responsibilities for the entity with which they are associated, and accordingly typically have different goals, different key performance indicators (KPI) and/or are more interested in different types of information and/or levels of information. As one simple, non-limiting example, a product category manager is focused on growing market share associated with the products with the respective product category, while a replenishment manager is interested in making sure optimum stock is replenished and available. Accordingly, the product category manager typically has significantly different objectives and/or key performance indicators than the replenishment manager. Accordingly, the product allocation control system 100 in some embodiments cooperatively uses a series of multiple different sets of machine learning models to identify potential anomalies, drill down in granularity to identify where along a retail product life cycle and/or retail facilities the anomalies are originating, evaluates factors to determine one or more likely causes of the respective anomalies, forecasts expected deviations from desired performance levels or strategies, and customizes information to present information that is predicted to be the most relevant for the particular intended recipient and the key performance indicators, goals and/or other such objectives associated with the tasks for which the intended recipient is responsible.

The anomaly detection system 102 is configured to evaluate extensive amounts of different types of information in identifying anomalies (sometimes referred to as exceptions) associated with one or more categories of products and/or individual products. Some examples of anomalies are threshold variations in quantities of sales, threshold variations in quantities of sales between two different times, threshold variations in quantities of sales over one or more durations of time, threshold variations in values or dollar amounts of sales of one or more categories of products and/or one or more products of a category over one or more predefined durations of time, threshold variations in a quantity or quantities of one or more categories of products and/or one or more products, and other such anomalies.

In some embodiments, the anomaly detection system 102 applies a series of machine learning anomaly detection models to business metrics data, such as but not limited to product data, inventory data, sales data and the like, relative to products being sold through a retailer, and/or other relevant information to identify one or more anomalies. For example, a series of anomaly detection models can be applied to sales data relative to products being sold through a retailer to identify an anomaly relative to a threshold variation in the respective one or more business metrics (e.g., sales) over time of a particular category of products and/or an individual product. Based on the identified anomaly, the product allocation control system 100 is further configured to provide information to one or more intended recipients regarding the anomaly. Again, however, different potential recipients and/or groups or personas of recipients have different responsibilities, KPIs and other such factors. As such, different recipient personas are interested in different details about an anomaly.

The anomaly detection system identifies alerts and exceptions through the application of the series of anomaly detection models, such as but not limited to Heuristics, Univariate time series based techniques, Multivariate, control limit, isolation forest and local outlier factor (LOF)—ensembles, deep learning models such as LSTM-based autoencoders, variational autoencoders, and/or other such machine learning models. Some embodiments further identify anomaly clustering and/or anomaly patterns. In some embodiments, the anomaly detection system 102 further applies a set of one or more machine learning clustering models relative to the plurality of different anomalies identified over time. The clustering aids in identifying a relevance of the detected anomalies and/or providing enhanced control over what and when anomaly information is reported, and/or a level of intensity of irregularities are to be highlighted to relevant recipients.

The contextualization detection system 108, in some embodiments, applies a set of machine learning contextual models to relevant business data (e.g., non-sales data, the sales data and/or other such information) relative to the anomaly and identifies contextual factors associated with the anomaly in identifying a contextual relevance of the anomaly to one or more factors of product allocation, distribution, sales, marketing and other such aspects of managing retail products and sales. Further, in some embodiments, the contextualization detection system in applying the set of contextual models applies historic period filtering relative to multiple different historic durations and/or statistical range based prioritization in identifying the contextual factors associated with the anomaly. Such contextual factors can be relative to different sales channels, and geographic hierarchy of sales, inventory, distribution, market trends, and/or other such information that can have an effect on one or more business metrics. Based on this identification of attributes, the causal detection system 110 identifies temporal context of the anomaly, which can include range based temporal context (e.g., multiple lookback periods using statistical bands), distribution based temporal context, and/or other such temporal context. Additionally or alternatively, some embodiments identify event based context of the anomaly, distribution based context (e.g., channel, supplier, shipper, etc.), geographic based context, and/or other such context. The contextualization of the anomaly further enables the system to provide more meaningful alerts and provide more relevant information about the cause of the anomaly and/or its relevance to the intended recipient(s). The context can be determined based on historical patterns, goals and/or expectations associated with the category of products, external factors (e.g., supply of materials, labor issues, weather, shipping, etc.), and/or other such factors. In part, the contextualization enables the system to provide reference points to detected anomalies and/or the factors having some effect in causing the anomaly and provide a relevance corresponding to the intended recipient. Accordingly, the identification of contextual factors provides further insight into what the anomaly is and a relevance to different aspects of what the anomaly is.

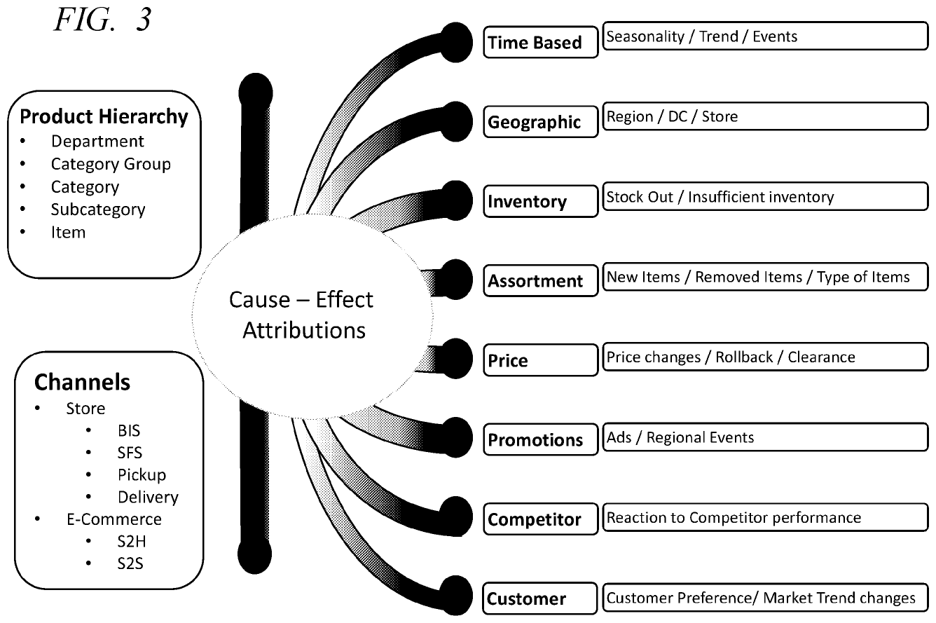

The causal detection system 110 applies a set of machine learning causal inference and determination models to sets of relevance data having potential effects on the category of products and/or specific product as a function of the contextual factors associated with the detected anomaly, and determines influence attribution factors that are predicted to have been factors in causing the respective threshold variation in one or more business metrics (e.g., sales) of products of the category of products. FIG. 3 is a pictorial representation of exemplary relationships of cause-effect influence attributions, in accordance with some embodiments. The influence attribution factors are utilized, at least in part, in providing more relevant information about why the anomaly is occurring instead of merely identifying that an anomaly has occurred. Such relevance can be identified based on one or more factors, such as but not limited to product hierarchy (e.g., department, category group, category, subcategory, item), shopping and/or fulfillment channels (e.g., store based channels (e.g., buy in store (BIS), ship from store (SFS), online pickup and delivery (OPD), pick up today (PUT), etc.), e-commerce channels (e.g., ship to home (S2H), ship to store (S2S), etc.), and/or other such channels), other such relevant factors, and typically a combination of two or more of such factors. In some embodiments, the causal detection system additionally or alternatively applies a set of machine learning attribution prioritization models to define relevancy scores to the influence attribution factors and prioritizes the influence attribution factors. Such prioritizations can be dependent on one or more factors, such as but not limited to an actionability associated with an attribution factor, gravity and/or degree of an effect, persistence, relevance, duration, an association between the intended recipient and the attribution, other such factors, and typically a combination of such factors. The prioritization, in part, aids in the identification of the relevance of at least factors in causing the anomaly relative to the intended recipient. Accordingly, some embodiments provide a prioritization at two levels or aspects. Anomaly or exception prioritization can be applied, where ranking can be applied to exceptions across multiple product hierarchies within a category. Further, attribution prioritization can include the ranking among the many attribution features that could be probable causes based on exception type, metric, relevance and other factors.

In some embodiments, the causal detection system in applying the causal inference and determination models, applies at least a first sub-set of one or more of the causal inference and determination models to internal contextual retail factors corresponding to actions managed by the retailer and corresponding to one or more products of the first category of products, and further applies a second sub-set of one or more of the causal inference and determination models to external contextual factors that are independent of actions by the retailer and associated with the one or more products of the first category of products. By considering both internal and external factors, the root cause or causes of the anomaly are more readily identified. Examples of internal factors can include one or more of price changes, promotions, retail events, product seasonality, and other such factors. Examples of external factors can include weather, regional and/or geographically specific events. social influences, and other such factors. In some embodiments, the causal detection system 110 provides a mapping of the cause-effect relationship between metric and attribution features, and can provide a scoring or other such relevance of the attribution factors based on relevance, importance, actionability, and the like. Utilizing attribution features, and mapping with the exception patterns, probable cause-effect relationships are defined in some embodiments as attribution scores and attribution flags. Correlation-based functions can be applied in anomaly detection based at least in part on the attribution features.

In identifying causation factors and/or causes, the causal detection system 110 typically further identifies causation factors and/or causes of the anomaly that are more relevant to the intended recipient and/or type of recipient (persona). In some embodiments, for example, the causal detection system 110, in applying the set of attribution prioritization models, further identifies a sub-set of the influence attribution factors that correspond to one or more actions that are controllable by an expected recipient and/or over which an expected recipient has some control. The sub-set of one or more actionable influence attribution factors are typically prioritized as more relevant than other attribute factors of the influence attribution factors. By applying such prioritization, the causal detection system 110 identifies and/or can highlight the probable attribution factors that make the anomaly notification information actionable by the particular intended recipient and/or type of intended recipient.

The identification of cause-effect attributions includes the evaluation of multiple influencing factors that drive the metric performance. For example, embodiments typically consider time based factors that help in explaining and/or distinguishing whether the metric deviations are because of seasonal patterns, specific events, and other such time based considerations. Similarly, embodiments evaluate geographic factors in, as part of a geographic drill down, which can aid in identifying where an anomaly is occurring and/or where events are occurring that cause the anomaly. Inventory factors are additionally considered in some embodiments (e.g., determining whether the sales are impacted because of inventory stock outs, low inventory, supply chain issues, etc.). Product assortment and/or variation can have an effect on sales and/or other business metrics. As such, some embodiments consider assortment factors (e.g., sales can deviate because of additions and/or deletions of products, change in modulars, changes product invisibility and placement of products in one or more stores, websites and the like, and/or other such assortment factors). Some embodiments evaluate price influence factors, which typically have significant impact on respective product sales. Other influencing factors can include promotions (e.g., planned promotions that are meant to influence and increase sales), competitor information (e.g., how a particular supplier is performing as compared of one or more or all competitor products), customer behavior changes (e.g., how market trends and changing customer demographics who are core buyers of a category impact the performance of the category), and/or other such influence factors. In some embodiments, different domains of cause-effect attributions are modeled using different techniques as appropriate.

Some embodiments include a forecast system 114 that applies a set of machine learning forecast models to identify one or more deviations between forecasted trends of a respective business metric relative to one or more products of a category of products relative to intended goals, KPIs, and the like. The forecasting can help provide insight in identifying actions that might be implemented cause course correct relative to the anomaly and/or plan for future actions. Some embodiments leverage known forecasting solutions. The forecasting further extends the anomaly detection to forecasts to measure against targets. The forecasting enables the anomaly notification information to include information about trends and patterns mapped against goals and/or other benchmarks, thresholds or the like.

The personalization recommendation system 112 applies a set of machine learning personalization models to the influence attribution factors and the contextual factors or aspects of the anomaly as a function of a particular recipient and/or recipient type or category, of multiple different recipient types, intended to receive personalized anomaly notification information, and compiles customized anomaly notification information that is predicted to be of more interest and/or relevant to the intended recipient type. Further, in some embodiments, the personalization recommendation system 112 is configured to control a display system to control a graphical user interface presenting the customized anomaly notification information specific to the intended recipient type and/or a specific intended recipient. Accordingly, the customized anomaly notification information does not merely identify an anomaly, but instead provide more detailed and extensive insight that is of particular relevance to a specific intended recipient type regarding where along the retail cycle the anomaly is occurring, why the anomaly is occurring, forecasts what is expected, and in some instances provides potential actions to address the anomaly. This information can include graphs, charts, spreadsheets, correlations, and/or other relevant information that can be used by the intended recipient. Still further, the graphical user interface typically includes functionality to expand on one or more aspects of the information provided and/or to access additional information and/or more detailed information.

Some embodiments further enhance the customized anomaly notification by providing a textual summary of one or more aspects of the anomaly notification information that is expected to be of particular relevance and/or importance to the intended recipient. The personalization recommendation system 112 in customizing the anomaly notification information, in some embodiments, is configured to present the textual summary identifying, for example, one or more threshold variations in business metrics over time of relative to the identified category of products, and explaining one or more relationships between a subset of the influence attribute factors and threshold variation in the business metric over time of the category of products, based on the prioritization and being associated with one or more key performance indicators relevant to the intended recipient type. This textual summary can quickly provide the intended recipient with relevant information in a succent and easily consumable format to allow rapid understanding of one or more relevant anomalies without having to dig through more detailed information, yet still providing further information and/or access to further information should the intended recipient want to obtain a more detailed understanding. In some instances the personalization recommendation system in presenting the textual summary further textually identifies relevant business metrics information, sales channels and/or geographic regions causing the threshold variation in the relevant business metric (e.g., sales) over time of one or more products of the category of products. In some embodiments, the personalization recommendation system utilizes the forecasting, and in presenting the textual summary further textually explains the deviation between a forecasted trend of the business metric corresponding to a category of products and/or products of the category relative to one or more intended goals, KPIs, other thresholds and/or benchmarks.

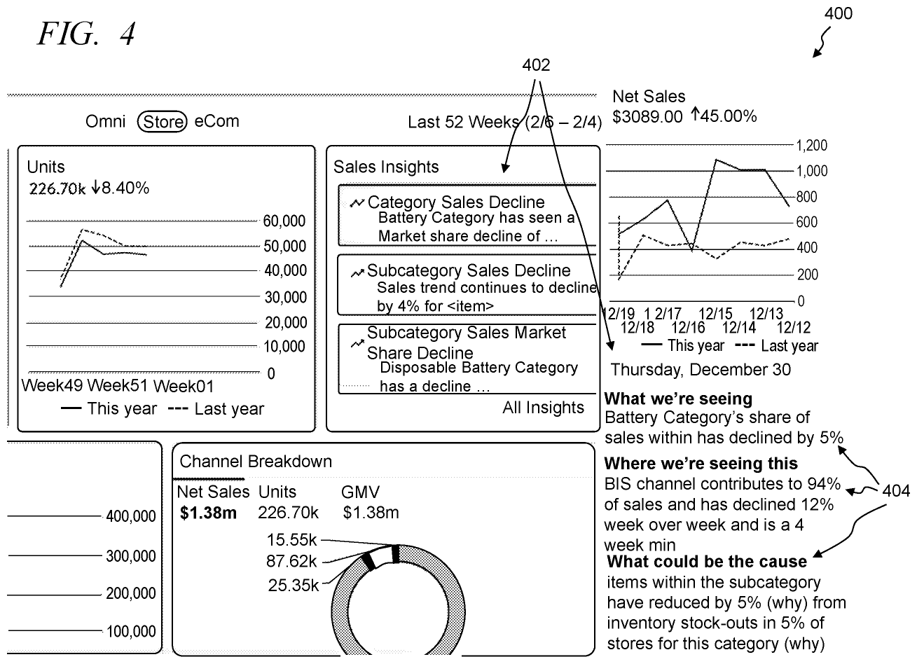

FIG. 4 illustrates a simplified representation of an example of customized anomaly notification information 400 displayed through a graphical user interface of one or more recipient computing devices 124, in accordance with some embodiments. As described above and further below, the customized anomaly notification information 400 includes various types of information identified as being of particular relevance to the receiving recipient. A graphical user interface (GUI) is controlled to present the customized anomaly notification information based on information determined to be most relevant to a particular intended recipient, in accordance with some embodiments. In some embodiments, the GUI enables the recipient to interact with the information, obtain more details for particular portions of the information, and collaborate with other potential recipients (e.g., tagging one or more portions of the information, indicating a preference or dislike for certain types of information, adding comments, searching for information, and/or other such interactions). Such interactions provide feedback to the system that is used by machine learning models in subsequent training of models, which in part enable more reliable information provided to different intended recipients.

In some embodiments, one or more collaboration areas 402 or spaces are provided that provide some of the relevant information (e.g., alerts, attributions for alerts, etc.) and, in some embodiments includes interactive functionalities that enable the recipient to interact with the information and/or graphical user interface through one or more clickstream functions (e.g., views, selection of one or more options, accessing other information, etc.), collaborations (e.g., thumbs up or down, predefined choices, text feedback, rating, tagging, etc.) and the like. Further, in some embodiments, the customized anomaly notification information includes one or more textual summaries 404 further textually explaining alerts, their causes, forecasted deviation between forecasted trends of one or more business metrics corresponding to products of a category of products relative to the intended goal, and/or other such information.

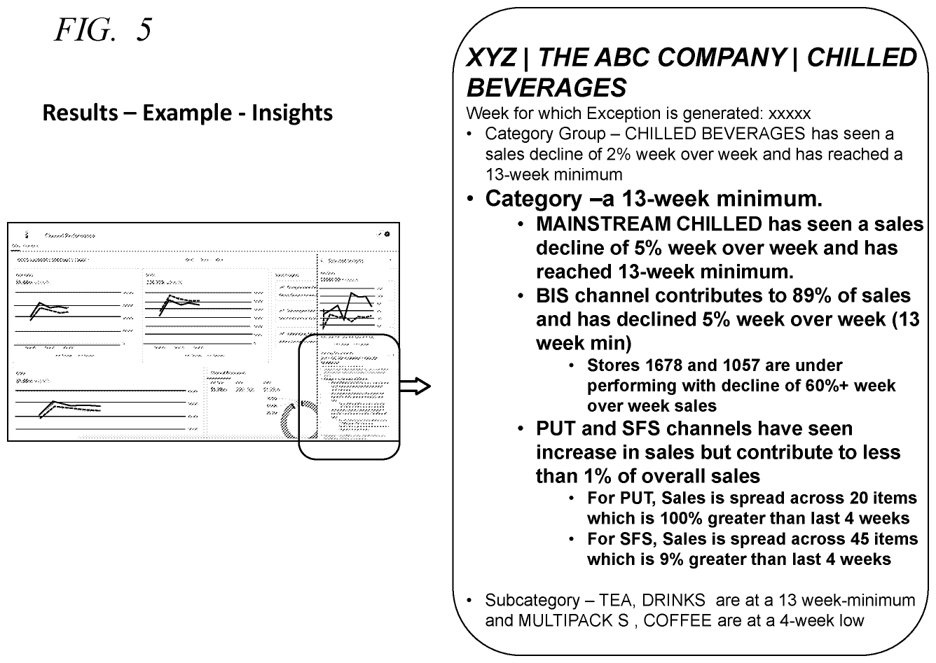

FIG. 5 illustrates simplified representation of an exemplary textual summary 404 of a customized anomaly notification information 400, in accordance with some embodiments. Again, anomaly notification information is customized for a particular intended recipient type and/or specific recipient. In some embodiments, the textual summary is similarly customized based on the intended recipient group and/or recipient. In customizing the anomaly notification information, the personalization recommendation system in some embodiments is configured to generate and present a different customized anomaly notification information intended for a different recipient type. The different customized anomaly notification information can comprise a different textual summary relevant to the different recipient type. For example, this different textual summary can identify the threshold variation in one or more business metrics over time of a first category of products, and explain a relationship between a subset of the influence attribute factors and the threshold variation in the relevant business metric over time of the category of products, based on the prioritization and being associated with a different set of one or more key performance indicators relevant to the intended recipient type.

The product allocation control system 100 further includes one or more model training systems 116 that are communicatively coupled with at least one or more model database maintaining trained models and one or more training data databases that stores relevant training data to train and/or retrain the anomaly detection models, the contextual models, the causal inference and determination models, the attribution prioritization models, the forecast models, the personalization models, other relevant models and/or machine learning algorithms. The model training system 116 includes one or more model training servers or managers, which are implemented through one or more computing systems, servers, computers, processor and/or other such systems communicatively coupled with one or more of the distributed communication networks 104, and are configured to build and/or train the machine learning models. In some implementations, the model training system 116 includes multiple sub-model training systems each associated with one or more of the different machine learning models.

The training data database stores and updates relevant training data. The training data includes historic data of recipients and their association with known companies, predefined profiles of types of recipients, predefined profiles of known preferences of information, predefined associations of responsibilities to types of recipients and other such information. Further, the training data includes historic business metrics data, such as historic sales data (e.g., quantities of products sold, pricing, pricing adjustments, etc.), typically for one or more years, in association with historic inventory information, historic marketing information, and other such information. Some embodiments further include historic anomaly detected events in relation to known historic causes of those historic anomaly events. The training data additionally includes historic information about different information supplied to and/or accessed by different users corresponding to thousands or more products from hundreds of different suppliers and/or manufactures and sold from multiple different retail stores distributed over multiple different geographic areas. Further, the training systems 116 is configured to receive feedback information at least through the graphical user interface corresponding to actions by the different recipients interfacing with the respective graphical user interface based on the rendered customized anomaly notification information. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system 116 utilizes the feedback information to repeatedly over time retrain the models to repeatedly provide over time retrained anomaly detection models, retrained contextual models, retrained causal inference and determination models, retrained attribution prioritization models, retrained forecast models, retrained personalization models, and/or other retrained machine learning algorithms that improve performance over time and enhance the identification of anomalies, and the identification of information that is more relevant to the invented recipient.

The training data databases can be local to the model training system, remote and accessible over one or more of the communication networks 104 or a combination of local and distributed. The model training system uses the relevant data to train the machine learning models. In some embodiments, one or more training processes are similar to the process performed by one or more models after having been trained, but can be trained with multiple sets of training data (e.g., some real and some simulated and/or synthetic for the sake of training). Predictions are compared to actuals to ensure that the set of models are operating with a certain threshold confidence. Further, the model training system 116 is configured to receive feedback information through the graphical user interface corresponding to actions by the recipient interfacing with the graphical user interface based on the rendered first customized anomaly notification information, and implement retraining based on the feedback information.

The above and below description includes descriptions of embodiments implementing and/or utilizing trained machine learning models and/or neural networks. In some embodiments, the neural network, machine learning models and/or machine learning algorithms may include, but are not limited to, Heuristics, Univariate time series based techniques, Multivariate, control limit, isolation forest and LOF—ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

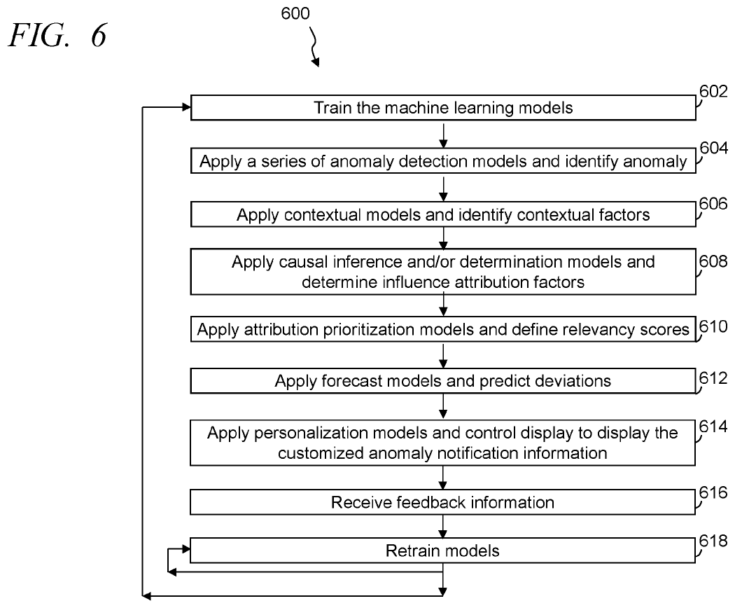

FIG. 6 illustrates a simplified flow diagram of an exemplary process 600 of controlling retail product allocation and providing customized anomaly notification information, in accordance with some embodiments. In step 602, anomaly detection models, contextual models, causal inference and determination models, attribution prioritization models, forecast models, personalization models, other relevant models and/or learning algorithms are trained and/or retrained using corresponding training data accessed from one or more training model databases and/or other such sources. As described above and further below, the training data can include historic sales data over one or more known periods of time, historic inventory data over one or more known periods of time, other historic metric data, predefined known data that indicates known anomalies, known association data identifying known associations between types of information, recipients, alerts, attributes, and the like, predefined product data, other such information, and typically a combination of two or more of such information.

In step 604, a series of anomaly detection models are applied to data from one or more internal and/or external data sources. The data can include channel performance data feeds, sales data relative to products being sold through a retailer, inventory data, shipping data, trends data, other metrics data and/or other relevant data. In some embodiments, the anomaly detection models are applied to one or business metrics data, and one or more anomalies are identified relative to respective threshold variations in the one or more business metrics over time of one or more categories of products and/or a specific product of a given category of products. Some embodiments include step 606 where a set of one or more contextual models are applied to non-sales data and the sales data relative to the first anomaly, and contextual factors are identified that are associated with the detected anomaly and relative to different sales channels and geographic hierarchy of sales. In applying the set of contextual models, some embodiments apply historic period filtering relative to multiple different historic durations and statistical range based prioritization to identify the contextual factors associated with the anomaly.

In step 608, a set of causal inference and determination models are applied to sets of relevance data having potential effects on the first category of products as a function of the contextual factors associated with the first anomaly, and influence attribution factors are determined that are predicted to have been factors in causing the threshold variation in one or more business metrics of products of the first category of product. Some embodiments, in determining the influence attribution factors additionally apply a first sub-set of one or more of the causal inference and determination models of the set of the causal inference and determination models to internal contextual retail factors corresponding to actions managed by the retailer and corresponding to one or more products of the category of products, and further apply a second sub-set of one or more of the causal inference and determination models to external contextual factors that are independent of actions by the retailer and associated with the one or more products of the first category of products.

In step 610, a set of attribution prioritization models are applied and one or more relevancy scores are defined to one or more of the influence attribution factors providing a prioritization of the influence attribution factors. In prioritizing the influence attribution factors, some embodiments identify a sub-set of the influence attribution factors that correspond to actions controllable by an expected recipient, of the recipient type, intended to receive the customized anomaly notification information, and prioritize the sub-set of the influence attribution factors as more relevant than other attribute factors of the influence attribution factors. For example, the sub-set of influence attribution factors may be more relevant to a particular KPI considered by the particular recipient, a responsibility managed by the particular recipient, an action that the particular recipient is to perform and/or other such factors.

Some embodiments include step 612 where a set of one or more forecast models are applied to predict a deviation between a forecasted trend of one or more business metrics corresponding to the products of the category of products relative to intended goals. In step 614, a set of personalization models are applied at least to the prioritized influence attribution factors and the contextual factors of the identified anomaly as a function of a particular intended recipient type, of multiple different recipient types, intended to receive personalized anomaly notification information to identify information that is of particular relevance to the intended recipient. Based on the identified information the customized anomaly notification information is compiled and a display system of a recipient computing device 124 is controlled to render a graphical user interface presenting the customized anomaly notification information specific to the intended recipient type. In some embodiments, the customizing of the anomaly notification information includes presenting a textual summary. The textual summary, in some instances, textually identifies one or more threshold variation in one or more business metrics over time of one or more products and/or all products of a category of products. Some embodiments further include a textual explanation of a relationship between a subset of one or more of the influence attribution factors and threshold variation in the respective business metric over time of the category of products, based on the prioritization and being associated with one or more key performance indicators relevant to the intended recipient type. The presentation of the textual summary, in some implementations, can further include textually identifying relevant business metrics information, sales channels and/or geographic regions causing the threshold variation in the relevant business metric (e.g., sales) over time of the category of products. Further, some embodiments, in compiling and/or presenting the textual summary further include textually explaining the deviation between the forecasted trend for the business metric of the products of the category of products relative to the intended goal.

In step 616, recipient feedback information is received through the rendered graphical user interface corresponding to actions by the recipient interfacing with the graphical user interface based on the rendered customized anomaly notification information. In step 618, one or more of the attribution prioritization models, and/or the personalization models are retrained through the model training systems 116 based on the recipient feedback information providing retrained attribution prioritization models and/or retrained personalization models.

As described above, different customized anomaly notification information is provided to different intended recipients and/or different types of recipients. Accordingly, in response to the same identified anomaly, the personalization recommendation system 112 can provide two or more different customized anomaly notification information with different information relative to different KPIs, different goals, different thresholds, and/or other such factors based on the two or more different customized anomaly notification information being intended for different types of recipient with different responsibilities. For example, some embodiments generate and present a different, second customized anomaly notification information intended for a different second recipient type, of the multiple different recipient types. The second customized anomaly notification information can include a different second textual summary relevant to a second recipient type. The second textual summary, in some implementations, can textually identify a threshold variation in sales and/or other business metric over time of the category of products, and textually explains a different second relationship between a second subset of the influence attribute factors and the threshold variation in the one or more business metrics over time of the category of products, based on the prioritization and being associated with a different second set of one or more key performance indicators relevant to the second recipient type.

As described above, the present embodiments in part enhance the identification of anomaly information, product information, product distribution information, demand information, other such retail information, and/or a combination of two or more of such information that is more relevant to a particular type of recipient and/or a particular recipient. Again, different potential recipients have different responsibilities, different goals, different KPIs, and/or are otherwise interested in different types of information (e.g., Sales/Account Manager (How are my brands selling vs goal? Which channels & markets are growing? How does execution & promotion look online & in-store, where do I improve?), Category Advisor (How do we optimize assortment? How to item, store & geographic drivers impact assortment and mod performance? What should the store mod/shelf layout look like? How & where should it vary?), Market Researcher/Marketing Manager (Are my brand's sales diverging from market/category trend? How are my brands/items doing as against my competitors? How are customer preferences affecting item sales growth/decline?), Retailer/Merchant (How are my suppliers selling vs goal? Which channels & markets are growing? How does execution & promotion look online & in-store, where do I improve?), Collaborative, Planning, Forecasting, and Replenishment (CPFR) Manager (Where am I in/out of stock? What's forecasted demand/PO? What's my OTIF look like?), Replenishment Manager (Where are my suppliers in/out of stock? How are my suppliers preparing for demand with upstream supply? How are my suppliers' OTIF scores?), etc.). Accordingly, the systems and methods enhance the distribution of information by identifying information that is expected to be most relevant to the type of recipient and/or the specific recipient. Still further, the systems and methods further improve performance over time through the continued retraining of machine learning models through feedback and updated training information, along with the use of the feedback to more accurately identify relevant information over time for the intended recipient. In part, some embodiments create and repeatedly update over time one or more a retail knowledge graphs connecting users, collaborators, items, metrics, insights, attributions and/or other entities. The maintained knowledge graph(s), user community and user feedback and/or impressions are leveraged to generate personalized insights recommendations that typically includes and/or are based on respective customized anomaly notification information. The personalized insights can connect a user to their most relevant metric with suitable attributions that are actionable by that user. For example, knowledge graphs that can be used include knowledge graphs described in corresponding U.S. Provisional Application No. 63/340,198, filed May 10, 2022, entitled Systems and Methods to Control Customized Performance Insight Through Machine Learning Based Knowledge Graphs, by Chandrashekharaiah et al., with Attorney Docket No. 8842-154414-USPR_7060US01, which is incorporated herein by reference in its entirety.

The customized anomaly notification information enable the users to make informed planning decisions in by effectively providing information identifying what (e.g., detects the anomalies and exceptions in KPIs and metrics), where (e.g., drills down to the lowest granularity of where the anomaly is originating), why (e.g., gets the probable cause-effects and root causes for the anomalies), next (e.g., forecast to measure trends against goal or strategy), and who (e.g., customize the insights to end user personas & preferences and surface the most relevant information). This information narrows down focus areas and provides guidance on key business KPIs from the extensive amount and widely varied data. Further, the customized information helps the end user in making faster and accurate decisions relative to business metrics. The use of historic information enables backward looking view on deviations from a desired goal and identifies a likely cause that led to not meeting target for past period. Further, the system provides forward looking views on what the trends look like and guidance regarding what can be done to meet targets. The accurate and continued monitory and reporting the most relevant information to particular recipients enables effective channel investment and planning decisions with smart recommendations based on foreseeing scenarios and recommending course of actions to empower suppliers with vital decision-making projections. Additionally, the information in part is simplified providing textualized insights of the most relevant information to drive interpretability and actionability, and personalized for user personas and user preferences.

The exceptions or anomaly detection system 102, in some embodiments, uses one or more anomaly detection techniques (e.g., Heuristics, Univariate Time series based techniques, control limit, Isolation Forest and local outlier factor (LOF)—ensemble, deep learning models such as LSTM-based autoencoders, variational autoencoders, etc.). Further, some embodiments scoring the anomalies based on one or more of impact, intensity, persistence and/or other such factors. Further, the contextualization detection system 108 provides meaningful notifications through, in part, temporal and event-based contextualization. The causal detection system 110 provides the probable attribution factors that make an Insight actionable. Some embodiments provide mapping between the cause-effect relationship between metric and attribution features, and apply soring of the attribution factors based on relevance, importance, actionability specific to the intended recipient type. Some embodiments include the forecast system 114 to provide forecasting to help course correct and plan for the future. In some implementations, the exception detection is extended to forecasts to measure against targets. The personalization recommendation system 112 provides customized anomaly notification information that can include textualized insights to drive interpretability and actionability. Some embodiments utilize knowledge graphs and/or algorithms that maintain linking information to more accurately identify the relevant information for a particular recipient type.

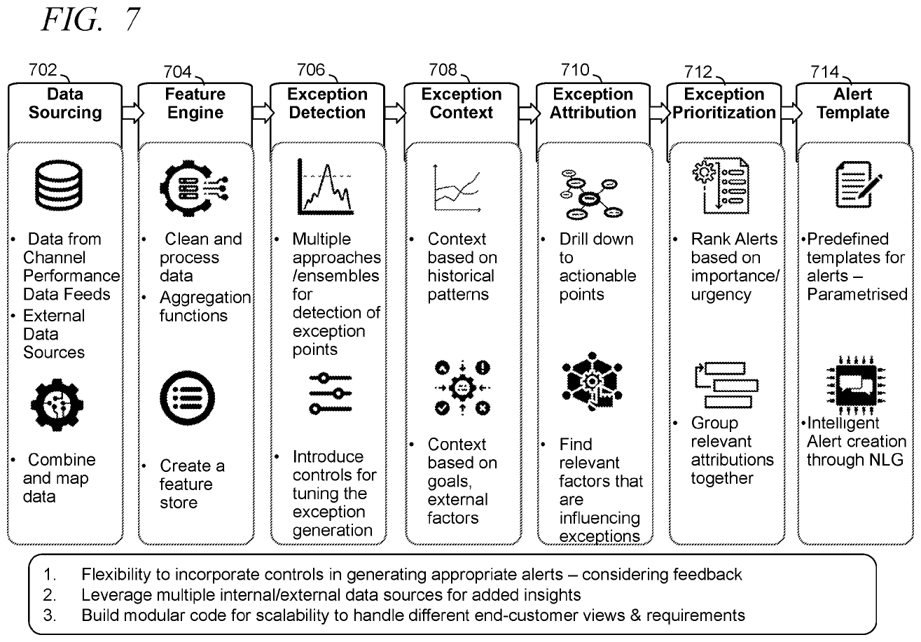

FIG. 7 illustrates a simplified functional block diagram illustrating functions of anomaly detection in accordance with some embodiments. One or more data sources are accessed. Such data can be internal retail data and other data can be external data. Some embodiments combine and map the data. Data is ingestion 702 from a variety of internal and external data sources that form rich gamut of input signals. Some of the internal data sources could be business KPIs such as: different retail hierarchies: items/SKUs, sub-category, category, category group, brands, etc.; different time/temporal slices: hourly, daily, weekly, monthly, quarterly, yearly, day-over-day, week-over-week, month-over-month, quarter-over-quarter, year-over-year, etc.; different channels: bought in stores or ecommerce; and different fulfillment channels: S2H (ship-to-home), S2S (ship-to-store), OPD (online pickup & delivery), PUT (pickup today), BIS (buy in store); inventory metrics—In-stock, Total on hand, In transit, PO raised Units; Sales metrics—Total sales in $, Total sale Units, AUR (average unit retail), GMV (gross merchandising value); OTIF (on time in full—fill-rate metrics); Market share metrics; Wastage and shrink metrics; Packaging metrics; Assortment metrics; etc. External factors can include, for example, weather, holidays, local events, etc. Other data sources can include privacy sensitive (PII protected) customer demographics and profiles, purchase histories, historic information, promotions information, pricing history information, user feedback (e.g., click-stream), advertising and/or marketing information, and/or other such external information.

Some embodiments include a feature engine 704 that process and/or cleans the data (e.g., eliminate extraneous information, consider potentially invalid information, note and/or remove duplicative information, etc.). In some embodiments, feature generation is performed where relevant metrics are collated and some additional features are derived (e.g., Seasonality index for Sales metrics, Growth Trend for Sales metrics, Sales Statistics for latest lookback periods for context, Sales to Inventory Ratio, Stockout counts, etc.). Further, some embodiments perform an aggregation, and create a feature store. The feature store is established and/or maintained, in some embodiments, through data cleansing and time aggregation. Further examples of features include but are not limited to time series related features (e.g., seasonality, sales growth, trend, last 4/13/52 week min/max/mean/variance, etc.), channel features (e.g., channel contribution, channel proportion change, etc.), assortment features (e.g., item count, new items count, removed items count, etc.) competitor features (e.g., brand proportion, supplier deviation from category average, etc.), and/or other such features.

As described above, one or more models and/or other methods are applied to identify anomalies 706. Anomaly detection, in some implementations, focuses on detecting anomalies or outliers in the metrics based on the historical patterns observed. Typically multiple different approaches are applied (Heuristics, Univariate Time series based techniques, Control Limit, Isolation Forest and LOF—ensemble, etc.) Some embodiments add thresholds based on anomaly scores coming from models gives ability to control the alerts for the outliers. Feedback is utilized to fine tune the models and/or other approaches over time to enhance the effectiveness and accuracy of detection.

The context of the anomalies are further evaluated 708 through one or more contextual models and based on historical information and/or patterns, goals and/or other factors. The context provides a reference to the detected anomalies. One or more causal inference and determination models can be applied to drill down to actional points and identify relevant factors that are influencing the anomaly. Some embodiments, for example, consider temporal context based on multiple lookback periods using statistical bands.

Anomaly attribution 710 are further identified. There are many influencing factors for each KPI or metric that are relevant to a particular recipient. Some embodiments utilize ML-based and stats-based causal-inference algorithms relative to outlier detected for a metric. For example, some embodiments identify location based focus areas by evaluating distribution of the metrics overlayed on geographical hierarchy, and/or channel based focus areas based on contribution and growth patterns across the channels through (e.g., Bollinger Band Analysis). Different influencing factors are analyzed and mapped against the outlier pattern (e.g., inventory stock-outs which can impact the sales metric; assortment changes that can impact sales deviations; category trend being followed by supplier's items or supplier's items going against the category performance trend; changing customer behavior patterns influencing the sales deviations; order transit loop creating inventory stock-outs, etc.).

Some embodiments further prioritize the anomalies 712 in attempts to bring the most impactful and actionable insights to the attention of the recipient. Some embodiments prioritize based on algorithms that perform a weighted ensemble of prioritization scores such as: volume of the Item or Item Hierarchy; Intensity of the deviation; Persistence of the unexpected pattern; Hierarchical priority based on occurrence of the alert across the full omni-hierarchy, and/or other such prioritization techniques. Some embodiments establish and/or maintain effect mappings. Prioritization ranks the anomalies to surface the most relevant and actionable cause.

Anomaly notifications are generated 714. Some embodiments provide textualization of the alerts that can be surfaced to the recipient user device through a graphical user interface, dashboard, messages email notifications, and/or other such methods. Quantified parameters from the anomaly detection are summarized in some embodiments to provide highlights of the insights (e.g., through NLP & NLG techniques).

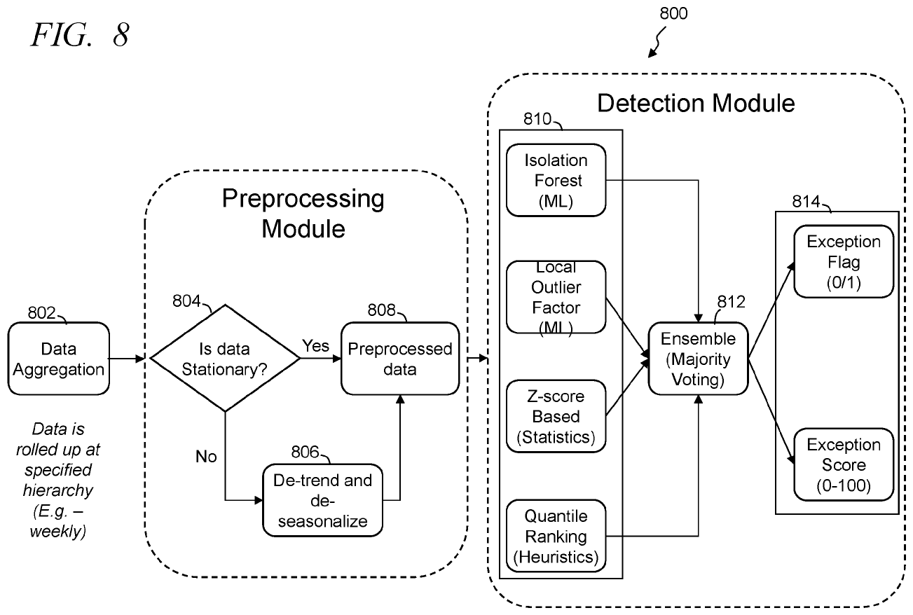

FIG. 8 illustrates a simplified flow diagram of an exemplary process 800 of anomaly detection, in accordance with some embodiments. In step 802, data is aggregated, and anomalies are identified (e.g., at daily, weekly and monthly levels for different item hierarchy levels). In step 804 it is determined whether data is stationary (e.g., perform an augmented Dickey-Fuller (ADF) test to test the stationarity of each input time series). This attempts to detect seasonal, trend or other such patterns, typically based on historical data. Some embodiments include step 806 where data is detrended and/or de-seasonalized, and the data is preprocessed in step 808. In step 810, the models are trained and/or retrained based on feedback. Multiple anomaly detection models can be leveraged that use some and typically the entire training data. FIG. 8 shows an example of some models that can be applied, however, other anomaly detection machine learning algorithms can be applied. Some embodiments include step 812, where the results of individual models are combined to obtain the final output. In some implementations, for example, for each data point, two values are returned in step 814—anomaly flag (0/1) and anomaly score (0-100).

The evaluation of anomalies are not limited to particular items. Instead, the systems and methods consider categories of products, but further evaluate individual products in identifying anomalies and the causes of anomalies. For example, a detected anomaly relative to a category of “chilled beverages” is further evaluated at one or more sub-categories (e.g., a “mainstream chilled beverages” sub-category, a set of secondary sub-categories of “juices”, “chilled coffees” and “chilled teas”, with a tertiary sub-categories of “black coffee” and “premium tea”). Based on the sub-category evaluations. the system can identify the anomalies at multiple different product hierarchies. Similarly, the system can weight the effects of different sub-categories in identifying the relevance of effect that a sub-category is having relative to one or more anomalies associated with the category. As a further example, sales patterns can be observed over a period of time (e.g., 2 years), and based on this pattern, the latest dates sales metric is categorized as being an anomaly (exception) or a normal behavior. Some embodiments perform the analysis across different aggregation levels of product hierarchy. Once an anomaly score is determined using the models, a weighted ensemble algorithm prioritizes the alert (e.g., based on one or more of a volume of the item or item hierarchy, impact of the exception, direction of the deviation, persistence of the deviation trend, etc.). Once an anomaly is detected, the contextualization provides a reference to describe what the anomaly is. Some embodiments may consider lookback periods of different durations and the current period's metric can be benchmarked against the distribution across the lookback periods. For this benchmarking, in some embodiments, statistical techniques of quantile based filtering and statistical range based prioritization can be performed. This provides an intuitive representation of the anomaly to the user in understanding why it is being called out as an anomaly. Once the anomaly has been detected and referenced the anomaly at product and/or product hierarchy level, some embodiments apply modeling to further drill down to narrower the focus areas that are actionable by the intended recipient. Some embodiments go down to granular analysis, looking at channel level analysis and geographic drill down (e.g., channel level—consider the different channels that are contributing to the overall sales and the channels that are driving the deviation in the sales; store level—looking at regions/stores that are heavily dominating the sales deviation, etc.). Further, some embodiments use of Bollinger Band technique for the channel attribution and hierarchical tree-based techniques through geographic levels for sales drill down.

Some embodiments consider cause-effect attributions based on multiple influencing factors that affect and/or drive one or more metric performances. For example: Time Based—explain if the metric deviations are because of seasonal patterns, or specific events; Geographic drill down—covered as part of identifying where an anomaly occurs; Inventory—if the sales is impacted because of inventory stock outs/low inventory/supply chain issues; Assortment—sales can deviate because of addition/deletion of items/change in modulars—visibility and placement of items in stores; Price—sales impacted by price changes on items; promotions—Planned Promotions that are meant to influence and increase sales, Marketing Promotions; Competitor Information—How the supplier is performing as compared of the average of rest of the competitors; Customer Behavior changes—How market trends and changing customer demographics who are core buyers of the category impact the performance of the category; etc.). In some implementations, different domains of the cause-effect attribution are modeled using different techniques as appropriate.

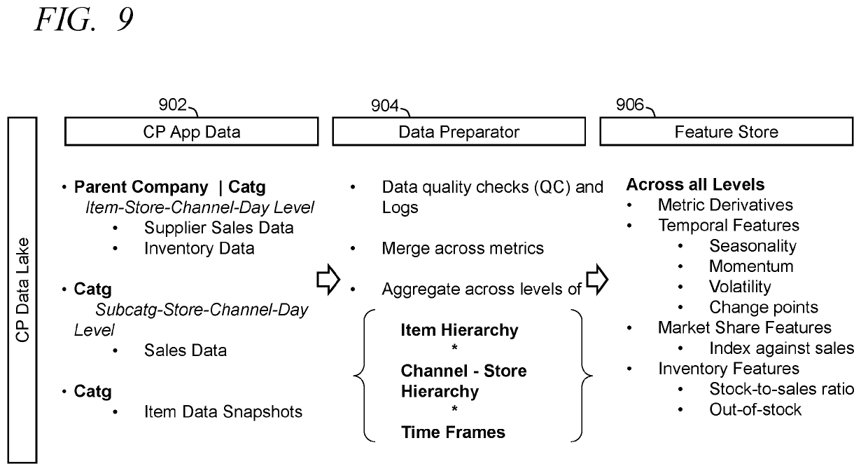

In some embodiments, the personalized insight pipeline is executed in three stages. FIGS. 9-11 illustrate three stages of providing the customized anomaly notification information, in accordance with some embodiments. FIG. 9 shows an exemplary data ingestion and feature store creation, in accordance with some embodiments. Raw data assets are considered 902, including channel performance (CP) data, and features relevant for exception detection and attribution are derived. This can include data ingestion, data preparation, and feature store creation. In data ingestion, raw data is ingested from, for example, channel performance data lake. For a Supplier-Category, supplier level data can be considered for metrics (e.g., sales, inventory, etc.) at one or more granular levels (e.g., Item-Store-Channel-Day). Some embodiments further consider relevant dim snapshots and/or other retail store level data. Data preparator 904 can aggregate and merge data to get data at varying levels, item hierarchy (e.g., category, subcategory(ies), product), store hierarchy (e.g., multiple fulfilment channels across store and ecommerce, and geographical drilldown at subdivision, region and store), time frames (e.g., daily, weekly, monthly), etc.). The feature store 906 is created, in some implementations, across multiple of the combinations of levels that arrived at the data preparator. Multiple features can be derived from metrics. Some embodiments further consider and/or incorporate internal factors for attribution.

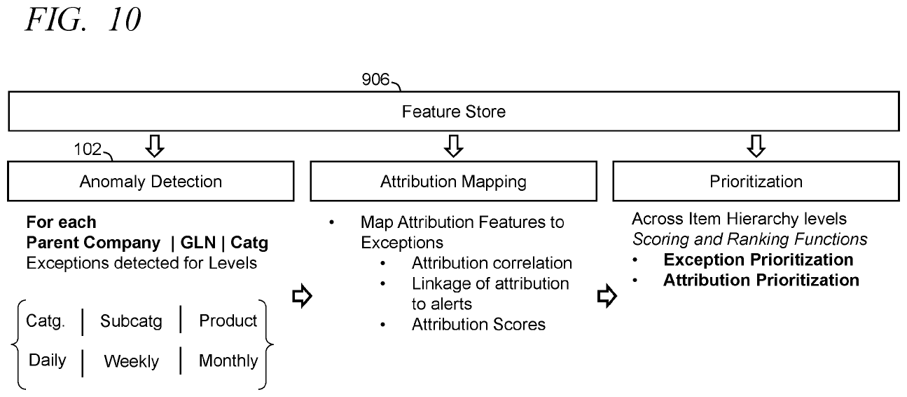

FIG. 10 shows an exemplary second stage of anomaly detection and attribution mapping, in accordance with some embodiments. Using the feature store 906 as foundation, the anomaly detection system 102 identifies anomalies, in some implementations at each level of item hierarchy and time frame. Some embodiments further provide exception scores and exception flags. The causal detection system 110, using the attribution features, and mapping with the exception patterns, defines probable cause-effect relationships, in some implementations, as attribution scores and attribution flags. Some embodiments utilize correlation-based functions, and anomaly detection can be based in part on the attribution features. The causal detection system 110 can further define the prioritization. Some embodiments perform prioritization at two levels: anomaly prioritization where, for example, the anomalies across multiple product hierarchies within a category are ranked, and attribution prioritization, where, among the many attribution features that could be probable causes, ranking is done based on exception type, metric, relevance, and/or other such factors. This provides one or more anomaly and attribution databases.

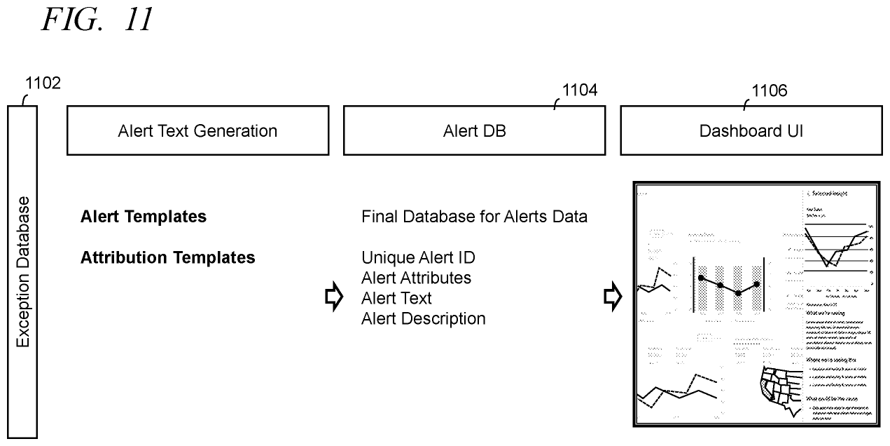

FIG. 11 illustrates an exemplary anomaly notification generation, with textual aspects of the alerts from the anomaly database 1102 to be surfaced on the graphical user interface insights dashboard, in accordance with some embodiments. Some embodiments utilize template based textualization functions, which feeds in predefined templates for alerts, and uses parameters derived in the previous stage(s) to generate the final the anomaly notification information. Some embodiments further provide an additional component of graphs that focuses on the metrics for alert context, where relevant parameters for the graph are also passed along with the alert texts. Some embodiments further create an anomaly database 1104 that is maintained with the relevant metrics that the user interface can pull in for surfacing. Accordingly, some embodiments provide a personalized smart system that feeds into a channel performance insights graphical user interface 1106 (e.g., dashboard), providing actionable and focused insights that drive effective strategy, planning and operations.

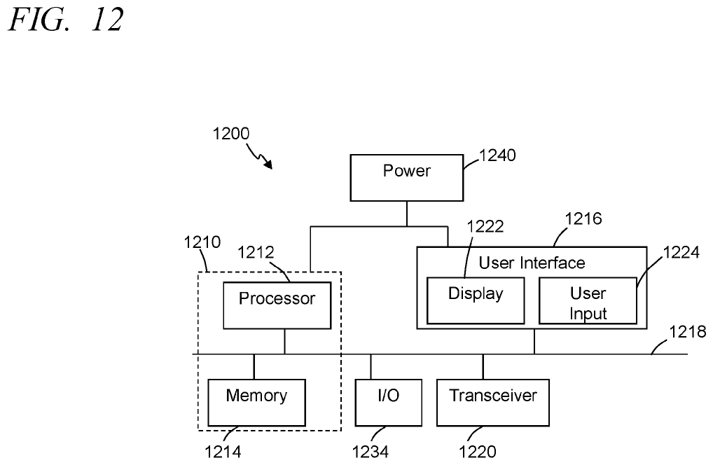

Further, the circuits, circuitry, systems, devices, processes, methods, techniques, functionality, services, servers, sources and the like described herein may be utilized, implemented and/or run on many different types of devices and/or systems. FIG. 12 illustrates an exemplary system 1200 that may be used for implementing any of the components, circuits, circuitry, systems, functionality, apparatuses, processes, or devices of the product allocation control system 100, and/or other above or below mentioned systems or devices, or parts of such circuits, circuitry, functionality, systems, apparatuses, processes, or devices. For example, the system 1200 may be used to implement some or all of the anomaly detection system 102, contextualization detection system 108, the causal detection system 110, the personalization recommendation system 112, the forecast system 114, the model training system 116, the recipient computing devices 124, and/or other such components, circuitry, functionality and/or devices. However, the use of the system 1200 or any portion thereof is certainly not required.

By way of example, the system 1200 may comprise a control circuit or processor module 1212, memory 1214, and one or more communication links, paths, buses or the like 1218. Some embodiments may include one or more user interfaces 1216, and/or one or more internal and/or external power sources or supplies 1240. The control circuit 1212 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1212 can be part of control circuitry and/or a control system 1210, which may be implemented through one or more processors with access to one or more memory 1214 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1200 may be used to implement one or more of the above or below, or parts of, components, circuits, systems, processes and the like.

The user interface 1216 can allow a user to interact with the system 1200 and receive information through the system. In some instances, the user interface 1216 includes a display 1222 and/or one or more user inputs 1224, such as buttons, touch screen, track ball, keyboard, mouse, etc., which can be part of or wired or wirelessly coupled with the system 1200. Typically, the system 1200 further includes one or more communication interfaces, ports, transceivers 1220 and the like allowing the system 1200 to communicate over a communication bus, a distributed computer and/or communication network 104 (e.g., a local area network (LAN), the Internet, wide area network (WAN), etc.), communication link 1218, other networks or communication channels with other devices and/or other such communications or combination of two or more of such communication methods. Further the transceiver 1220 can be configured for wired, wireless, optical, fiber optical cable, satellite, or other such communication configurations or combinations of two or more of such communications. Some embodiments include one or more input/output (I/O) ports 1234 that allow one or more devices to couple with the system 1200. The I/O ports can be substantially any relevant port or combinations of ports, such as but not limited to USB, Ethernet, or other such ports. The I/O interface 1234 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

The system 1200 comprises an example of a control and/or processor-based system with the control circuit 1212. Again, the control circuit 1212 can be implemented through one or more processors, controllers, central processing units, logic, software and the like. Further, in some implementations the control circuit 1212 may provide multiprocessor functionality.

The memory 1214, which can be accessed by the control circuit 1212, typically includes one or more processor-readable and/or computer-readable media accessed by at least the control circuit 1212, and can include volatile and/or nonvolatile media, such as RAM, ROM, EEPROM, flash memory and/or other memory technology. Further, the memory 1214 is shown as internal to the control system 1210; however, the memory 1214 can be internal, external or a combination of internal and external memory. Similarly, some or all of the memory 1214 can be internal, external or a combination of internal and external memory of the control circuit 1212. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 104. The memory 1214 can store code, software, executables, scripts, data, content, lists, programming, programs, log or history data, user information, customer information, product information, and the like. While FIG. 12 illustrates the various components being coupled together via a bus, it is understood that the various components may actually be coupled to the control circuit and/or one or more other components directly.

In some applications, the anomaly detection system further applies alert prioritization machine learning models in prioritizing the alerts as a function of actionability, urgency, and/or other such factors. In some embodiments, the prioritization includes defining a scoring and/or controls associated with the alert (e.g., scoring the exceptions based on impact, intensity, persistence and other relevant factors in prioritizing the exceptions).

The contextualization detection system applies a set of machine learning contextual models to relevant information (e.g., non-sales data and the sales data) relative to the first anomaly and identifying contextual factors associated with the first anomaly relative to different sales channels and geographic hierarchy of sales. The contextualization can include the identification of temporal contexts (e.g., range based context, distribution based context, etc.), event based contexts, and/or other such context. The causal detection system applies a set of machine learning causal inference and determination models to sets of relevance data having potential effects on the first category of products as a function of the contextual factors associated with the first anomaly, determines influence attribution factors that are predicted to have been factors in causing the threshold variation in one or more metrics of products of the first category of products, and applies a set of machine learning attribution prioritization models to define relevancy scores to the influence attribution factors and prioritize the influence attribution factors. The attributions can be based on internal retail factors (e.g., price changes, promotions, events, seasonality, etc.) and/or external factors (e.g., weather, regional events, social influences, etc.). Similarly, some embodiments further consider customer behavioral trends, the attribution relevancy score, and/or other such factors.

Some embodiments include a forecast system that applies a set of machine learning forecast models to identify deviations between predicted trends relative to intended goals. The forecasting can provide granular level of forecasts, including at multiple different retail sales channel levels (e.g., in-store, order and pickup, order and ship, e-commerce, etc.). Further, the forecasting, in some embodiments can provide exceptions or deviations from forecasts as against goals or thresholds. For example, trends and patterns can be mapped against goals.

The personalization recommendation system applies a set of machine learning personalization models to the prioritized influence attribution factors and the contextual factors of the first anomaly as a function of a particular first recipient type, of multiple different recipient types, intended to receive personalized anomaly notification information and controlling a display system to control a graphical user interface presenting first customized anomaly notification information specific to the first recipient type. This personalization can cater to different types of users and/or user personas (e.g., sales manager, replenishment manager, category manager, category merchant, etc.) each typically having different key performance indicators (KPI), goals, expectations, responsibilities and the like. The customized information specific to the intended recipient type and/or the specific individual person greatly aids that individual in addressing conditions specific to their responsibilities. In some embodiments, the personalization recommendation system further provides recommendation based, for example, on ranking of alerts, active-learning from user feedback, and/or other such considerations. The textualized insights, in some embodiments, is provide in part through natural language processing (NLP), natural language understanding (NLU), and natural language generation (NLG), design patterns and/or other such methods.

Some embodiments provide a system to control retail product allocation, comprising: an anomaly detection system applying a series of machine learning anomaly detection models to business metric data relative to products being sold through a retailer to identify a first anomaly relative to a threshold variation in a business metric over time of a first category of products; a contextualization detection system applying a set of machine learning contextual models to non-sales data and the sales data relative to the first anomaly and identifying contextual factors associated with the first anomaly relative to different sales channels and geographic hierarchy of sales; a causal detection system applying a set of machine learning causal inference and determination models to sets of relevance data having potential effects on the first category of products as a function of the contextual factors associated with the first anomaly, determining influence attribution factors that are predicted to have been factors in causing the threshold variation in the business metric of products of the first category of products, and applying a set of machine learning attribution prioritization models to define relevancy scores to the influence attribution factors and prioritize the influence attribution factors; a personalization recommendation system applying a set of machine learning personalization models to the prioritized influence attribution factors and the contextual factors of the first anomaly as a function of a particular first recipient type, of multiple different recipient types, intended to receive personalized anomaly notification information and controlling a display system to control a graphical user interface presenting first customized anomaly notification information specific to the first recipient type.

In some embodiments, a method controls retail product allocation, comprising: identifying, based on applying a series of machine learning anomaly detection models to business metric data relative to products being sold through a retailer, a first anomaly relative to a threshold variation in the business metric over time of a first category of products; identifying, based on applying a set of machine learning contextual models to non-sales data and the sales data relative to the first anomaly, contextual factors associated with the first anomaly relative to different sales channels and geographic hierarchy of sales; determining, based on applying a set of machine learning causal inference and determination models to sets of relevance data having potential effects on the first category of products as a function of the contextual factors associated with the first anomaly, influence attribution factors that are predicted to have been factors in causing the threshold variation in the business metric of products of the first category of product; defining, based on applying a set of machine learning attribution prioritization models, relevancy scores to the influence attribution factors and prioritizing the influence attribution factors; and applying a set of machine learning personalization models to the prioritized influence attribution factors and the contextual factors or aspects of the first anomaly as a function of a particular first recipient type, of multiple different recipient types, intended to receive personalized anomaly notification information, and controlling a display system to control a rendering of a graphical user interface presenting first customized anomaly notification information specific to the first recipient type.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system to control retail product allocation, comprising:
an anomaly detection system applying a series of machine learning anomaly detection models to business metric data relative to products being sold through a retailer to identify a first anomaly relative to a threshold variation in a business metric over time of a first category of products;
a contextualization detection system applying a set of machine learning contextual models to non-sales data and sales data relative to the first anomaly and identifying contextual factors associated with the first anomaly relative to different sales channels and geographic hierarchy of sales;
a causal detection system applying a set of machine learning causal inference and determination models to sets of relevance data having potential effects on the first category of products as a function of the contextual factors associated with the first anomaly, determining influence attribution factors that are predicted to have been factors in causing the threshold variation in the business metric of products of the first category of products, and applying a set of machine learning attribution prioritization models to define relevancy scores to the influence attribution factors and prioritize the influence attribution factors;
a personalization recommendation system applying a set of machine learning personalization models to the prioritized influence attribution factors and contextual factors of the first anomaly as a function of a particular first recipient type, of multiple different recipient types, intended to receive personalized anomaly notification information and controlling a display system to control a graphical user interface presenting first customized anomaly notification information specific to the first recipient type.

2. The system of claim 1, further comprising:
a training system configured to receive feedback information through the graphical user interface corresponding to actions by a first recipient interfacing with the graphical user interface based on the first customized anomaly notification information, and retraining based on the feedback information one or more of the attribution prioritization models of the set of attribution prioritization models and the personalization models of the set of personalization models providing retrained attribution prioritization models and retrained personalization models.

3. The system of claim 1, wherein the personalization recommendation system in customizing the anomaly notification information is configured to present a first textual summary identifying the threshold variation in the business metric over time of the first category of products, and explaining a first relationship between a first subset of the influence attribution factors and threshold variation in the business metric over time of the first category of products, based on the prioritization and being associated with one or more key performance indicators relevant to the first recipient type.

4. The system of claim 3, wherein the personalization recommendation system in presenting the first textual summary further textually identifies relevant sales channels and geographic regions causing the threshold variation in the business metric over time of the first category of products.

5. The system of claim 4, further comprising:
a forecast system applying a set of machine learning forecast models to identify a deviation between a forecasted trend of the business metric corresponding to the products of the first category of products relative to an intended goal;
wherein the personalization recommendation system in presenting the first textual summary further textually explains the deviation between the forecasted trend of the business metric of the products of the first category of products relative to the intended goal.

6. The system of claim 3, wherein the personalization recommendation system in customizing the anomaly notification information is configured generate and present a second customized anomaly notification information intended for a different second recipient type, of the multiple different recipient types, wherein the second customized anomaly notification information comprises a different second textual summary relevant to a second recipient type, wherein the second textual summary identifies the threshold variation in the business metric over time of the first category of products, and explaining a second relationship between a second subset of the influence attribution factors and the threshold variation in the business metric over time of the first category of products, based on the prioritization and being associated with a different second set of one or more key performance indicators relevant to the second recipient type.

7. The system of claim 1, wherein the causal detection system in applying the set of causal inference and determination models to the sets of relevance data comprises applying a first sub-set of one or more of the causal inference and determination models of the set of the causal inference and determination models to internal contextual retail factors corresponding to actions managed by the retailer and corresponding to one or more products of the first category of products, and further applying a second sub-set of one or more of the causal inference and determination models of the set of the causal inference and determination models to external contextual factors that are independent of actions by the retailer and associated with the one or more products of the first category of products.

8. The system of claim 1, wherein the causal detection system in applying the set of attribution prioritization models is configured to identify a sub-set of the influence attribution factors that correspond to actions controllable by an expected first recipient, of the first recipient type, intended to receive the first customized anomaly notification information, and prioritize the sub-set of the influence attribution factors as more relevant than other attribute factors of the influence attribution factors.

9. The system of claim 1, wherein the contextualization detection system in applying the set of contextual models is configured to apply historic period filtering relative to multiple different historic durations and statistical range based prioritization in identifying the contextual factors associated with the first anomaly.

10. A method of controlling retail product allocation, comprising:
identifying, based on applying a series of machine learning anomaly detection models to business metric data relative to products being sold through a retailer, a first anomaly relative to a threshold variation in a business metric over time of a first category of products;
identifying, based on applying a set of machine learning contextual models to non-sales data and sales data relative to the first anomaly, contextual factors associated with the first anomaly relative to different sales channels and geographic hierarchy of sales;
determining, based on applying a set of machine learning causal inference and determination models to sets of relevance data having potential effects on the first category of products as a function of the contextual factors associated with the first anomaly, influence attribution factors that are predicted to have been factors in causing the threshold variation in the business metric of products of the first category of product;
defining, based on applying a set of machine learning attribution prioritization models, relevancy scores to the influence attribution factors and prioritizing the influence attribution factors; and
applying a set of machine learning personalization models to the prioritized influence attribution factors and contextual factors of the first anomaly as a function of a particular first recipient type, of multiple different recipient types, intended to receive personalized anomaly notification information, and controlling a display system to control a rendering of a graphical user interface presenting first customized anomaly notification information specific to the first recipient type.

11. The method of claim 10, further comprising:
receiving feedback information through the graphical user interface corresponding to actions by the first recipient interfacing with the graphical user interface based on the first customized anomaly notification information; and
retraining, based on the feedback information, one or more of the attribution prioritization models of the set of attribution prioritization models and the personalization models of the set of personalization models providing retrained attribution prioritization models and retrained personalization models.

12. The method of claim 10, wherein the customizing the anomaly notification information comprises presenting a first textual summary comprising:
textually identifying the threshold variation in the business metric over time of the first category of products; and
textually explaining a first relationship between a first subset of the influence attribution factors and threshold variation in the business metric over time of the first category of products, based on the prioritization and being associated with one or more key performance indicators relevant to the first recipient type.

13. The method of claim 12, wherein the presenting the first textual summary further comprising textually identifying relevant sales channels and geographic regions causing the threshold variation in the business metric over time of the first category of products.

14. The method of claim 13, further comprising:
identifying, based on applying a set of machine learning forecast models, a deviation between a forecasted trend of the business metric corresponding to the products of the first category of products relative to an intended goal; and
wherein the presenting the first textual summary further comprises textually explaining the deviation between the forecasted trend of the business metric of the products of the first category of products relative to the intended goal.

15. The method of claim 12, wherein the customizing the anomaly notification information comprises:
generating and presenting a second customized anomaly notification information intended for a different second recipient type, of the multiple different recipient types, wherein the second customized anomaly notification information comprises a different second textual summary relevant to a second recipient type, wherein the second textual summary textually identifies the threshold variation in the business metric over time of the first category of products, and textually explains a second relationship between a second subset of the influence attribution factors and the threshold variation in the business metric over time of the first category of products, based on the prioritization and being associated with a different second set of one or more key performance indicators relevant to the second recipient type.

16. The method of claim 10, wherein the determining the influence attribution factors comprises:
applying a first sub-set of one or more of the causal inference and determination models of the set of the causal inference and determination models to internal contextual retail factors corresponding to actions managed by the retailer and corresponding to one or more products of the first category of products; and
further applying a second sub-set of one or more of the causal inference and determination models of the set of the causal inference and determination models to external contextual factors that are independent of actions by the retailer and associated with the one or more products of the first category of products.

17. The method of claim 10, wherein the prioritizing the influence attribution factors comprises identifying a sub-set of the influence attribution factors that correspond to actions controllable by an expected first recipient, of the first recipient type, intended to receive the first customized anomaly notification information; and
prioritizing the sub-set of the influence attribution factors as more relevant than other attribute factors of the influence attribution factors.

18. The method of claim 10, wherein the applying the set of contextual models comprises applying historic period filtering relative to multiple different historic durations and statistical range based prioritization, and identifying the contextual factors associated with the first anomaly.
